(19) United States
(12) Patent Application Publication
(10) Pub. No.: US 2022/0083441 A1
(43) Pub. Date: Mar. 17, 2022

(54) DATA MONITORING

(71) Applicant: Hewlett-Packard Development Company, L.P., Spring, TX (US)

(72) Inventors: Christoph Graham, Spring, TX (US); Xiao-Lu Zhang, Shanghai (CN); Shu-Wu Shi, Shanghai (CN); Wen-Jie Jiang, Shanghai (CN); Jie Xu, Shanghai (CN); Chen Si, Shanghai (CN); Xiaofei Zhu, Shanghai (CN)

(73) Assignee: Hewlett-Packard Development Company, L.P., Spring, TX (US)

(21) Appl. No.: 17/419,240

(22) PCT Filed: May 13, 2019
(86) PCT No.: PCT/US2019/031953

§ 371 Date: Jun. 28, 2021

(51) Int. Cl. G06F 11/30; G06F 11/32

(52) U.S. Cl. CPC G06F 11/3072; G06F 2201/86; G06F 11/321; G06F 11/3006

(57) ABSTRACT

Example implementations relate to data monitoring. An example non-transitory machine-readable medium can include instructions executable by a processor to request, from an agent device on a particular computing device of a plurality of computing devices, monitoring of a particular piece of data associated with the particular computing device. The instructions can be executable to retrieve the event responsive to the agent device detecting an event including a change in the particular piece of data during the monitoring and report the event via a graphical user interface.

### BACKGROUND

Device management includes configuring and deploying applications to computing devices with a network (e.g., an organization network) such as personal computers (PCs), laptops, and mobile devices. Device management can include providing centralized control of the computing devices.

### BRIEF DESCRIPTION OF THE DRAWINGS

FIG. 1 illustrates a system for data monitoring including a controller, a graphical user interface (GUI), and agent devices according to an example;

FIG. 2 illustrates another system for data monitoring including a processor and a non-transitory machine-readable medium (MRM);

FIG. 3 illustrates a diagram of a controller including a processor, a memory resource, and engines according to an example; and

FIG. 4 illustrates a method for data monitoring according to an example.

### DETAILED DESCRIPTION

As device management evolves, end users (e.g., administrators) may desire to collect specific data such as telemetry or configuration data about computing devices and the computing device environment. For instance, the data can include operating system (OS) data, application data, hardware configuration data, peripheral data, or usability data, among others. The data, for instance, may be used to drive automation processes of a device management controller, test end user assumptions, feed analytical curiosity of end users, confirm computing device user behaviors, or drive decision points for end users. As used herein, a computing device can be a mechanical or electrical device that transmits or modifies energy to perform or assist in the performance of human tasks. Examples include thin clients, personal computers, printing devices, laptops, tablets, smartphones, mobile devices, and gaming consoles, among others.

Some approaches to device management include the collection of all data from all computing devices of a network followed by filtering of the data to find the desired data. In other approaches, if a particular data type is added to a list for collection, every computing device collects the particular data type. These approaches can be time-consuming and can create network bandwidth issues. Other approaches apply customer requests for data to existing inventory schedules, which does not allow for real time monitoring of data changes or for sending data only when the data is changed.

In contrast, examples of the present disclosure provide for collection of data from a collection of computing devices (or a single computing device) based on an end user's desire to collect custom data and the end user's ability to gather such data from relevant system resources. For instance, some examples allow for flexible, granular, and custom collection of telemetry data, configuration data, etc. such that specific data from specific computing devices can be collected using an agent device on the computing device. The agent device can be embedded in the computing device such that it is nonintrusive. The agent device may be pre-configured on the computing device, sent through a management framework, or installed manually, among others. Such data can be sent to a controller (e.g., a server) only when a change occurs, which can reduce network bandwidth issues. Additionally and/or alternatively, the data can be sent in real time, such that the device is constantly monitored by the agent device, and any data changes are sent responsive to detection of the change. In some examples of the present disclosure, a repository of data for use in requesting particular data from particular computing devices can be created.

Some examples of the present disclosure allow end users to customize data monitoring by choosing which data they deem relevant, in contrast to other approaches that predetermine which data is relevant without user input. For instance, a particular end user may deem specific attributes of a computing device relevant that other end users may not. For instance, a first end user may decide a particular business logic attribute is important to monitor, while a second end user may disregard that particular business logic attribute, but instead choose to monitor a particular software program on particular computing devices. These examples of the present disclosure allow for efficient collection of desired data. For instance, if a network includes 100,000 computing devices, collection and sorting of data from all of those computing devices may be inefficient. Examples of the present disclosure allows for collection of only particular, targeted data from particular, targeted computing devices, such as 40 computing devices of the 100,0000 computing devices, resulting in improved efficiency.

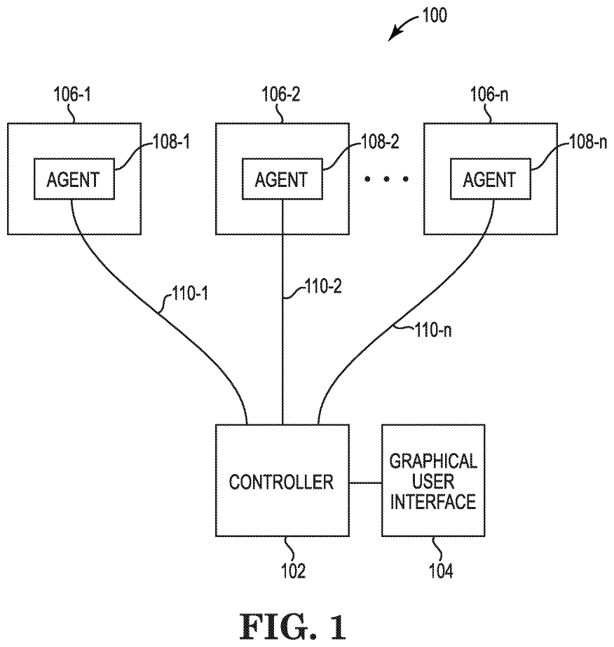

FIG. 1 illustrates a system 100 for data monitoring including a controller 102, a graphical user interface (GUI) 104, and agent devices 108-1, 108-2, . . . , 108-n (referred to herein after collectively as agent devices 108) according to an example. The agent devices 108 can be housed (e.g., deployed) on a different one of a plurality of associated computing devices 106-1, 106-2, . . . , 106-n (herein after referred to collectively as computing devices 106). The controller 102 can be communicatively coupled to the GUI 104, computing devices 106, and/or agent devices 108. As used herein, “communicatively coupled” can include coupled via various wired and/or wireless connections between devices such that data can be transferred in various directions between the devices. The coupling need not be a direct connection, and in some examples, can be an indirect connection. The controller 102 can be responsible for deploying tasks (e.g., requests for particular data from particular computing devices) to individual computing devices 106 for execution and gathering of responses to those tasks.

The agent devices 108 can monitor an associated computing device 106 for changes to a particular data type and notify the controller 102 of a change to the particular data type responsive to detection of the change. For instance, the controller 102 can receive a request for the particular data type associated with a particular computing device 106. The request, for instance, may come via the GUI 104. The controller can deploy instructions to the agent devices 108 to perform the monitoring for the particular data type, for instance in response to the request. The controller 102 can retrieve and compile notifications from the agent devices 108.

For instance, an end user may desire a particular data type such as software update data from a particular computing device or computing devices. The end user may desire to know if the particular computing device, a subset of computing devices, or all of the computing devices have undergone an update of a particular software. The controller 102 can request the particular data type from the particular computing devices 106 via the agent devices 108. The computing devices 106 can be managed by and can communication with the controller 102 to fulfill tasks (e.g., the request for the software update data) for which the controller asks. In such an example, the controller 102 (e.g., a management server) can receive the task from an end user via the GUI 104. The controller 102 can send the task to applicable agent devices 108 responsive to receipt of the task via the GUI 104.

For instance, if a single computing device such as the computing device 106-1 is the targeted computing device, the controller 102 can instruct the agent device 108-1 to monitor the computing device 106-1. If a subset of computing devices such as the computing devices 106-1 and 106-2 are the targeted computing devices, the controller 102 can instruct the agent devices 108-1 and 108-2 to monitor their respective computing devices 106-1 and 106-2. If all of the computing devices including the computing devices 106-1, 106-2, . . . , 106-n are the targeted computing devices, the controller 102 can instruct the agent devices 108-1, 108-2, . . . , 108-n to monitor their respective computing devices. The agent devices 108 can be services that run on the computing devices 106.

Applications can be deployed from the controller 102 to the agent devices 108 to collect or generate the data that is reported back to the agent devices 108 and then the controller 102. An agent device 108 may receive the data via an inter-process communication channel, and this channel can allow for the agent device 108 to execute instructions to collect the data and monitor the computing device 106 for data changes on the communication channel. When a change is detected by the agent device 108, the agent device 108 can send the associated data and the identity of the associated computing device 106 to the controller 102. For example, the agent device 108 can run a script on intervals to detect a change in the data, create an event including the change, and report to the control 102.

An example may include a customized subset of computing devices 106 including the computing devices 106-1 and 106-2, and if the agent device 108-1 detects the software update to the computing device 106-1 identified in the task (e.g., the data type desired for collection), that data can be sent to the controller 102 either responsive to the change detection or at a predetermined time interval (e.g., data can be sent every minute, every 5 minutes, every hour, every 24 hours, etc.). If, at the same time, the agent device 108-2 does not detect a software update to the computing device 106-2 identified in the task, no data is sent to the controller 102 from agent device 108-2. Put another way, data may be sent from an agent device 108 to the controller 102 only when a change is detected at its respective computing device 106. In other examples, data may be sent from the agent devices 108 to the controller 102 periodically but may still only be sent if a change has been detected to a respective computing device 106. While examples herein describe the particular data type as software update data, other data types may be gathered.

In some examples, customizable properties can be a specialized form of task where an end user (e.g., administrator) defines what data he or she is interested in on which computing device or computing devices, as well as a process used to collect the data. This can be, for instance, an executable program or an interpreted script (e.g., a shell script, a scripting language, etc.). These scripts or executables can be used to monitor attributes of the particular computing device 106 for changes to the particular computing device 106 or can be used to run on a defined interval polling for changes to computing device data. As a result, in some examples, the agent device 108 communicates with the controller 102 only when a change is detected, and in other examples, the agent device 108 communicates with the controller 102 periodically.

In some examples, the monitoring and notification is performed iteratively. For instance, the monitoring and notification does not end when a single change is detected. Rather, the monitoring can be near-continuous such that the computing device is near-continuously monitored until instructions come to cease monitoring. As used herein, near-continuously includes monitoring without meaningful breaks. For instance, the computing devices 106 can be near-continuously monitored for software updates of a particular type with notifications sent to the controller 102 with each change detected. This process can be iterative such that the monitoring and notification continuous until an outside source stops it (e.g., an administrator ceases the monitoring, a power outage, etc.).

Examples of the present disclosure allow for an end user to define the particular data he or she desires, a process for collecting the data (e.g., script or executable), and a set of particular computing devices 106 from which to collect the particular data. The end user can define a plurality of combinations of data and computing devices within his or her managed computing device ecosystem. The end user can create, deploy, monitor, and retire custom data via the GUI 104. Within the GUI 104 may be customizable views and an interface for sorting and filtering computing device data including data collected from custom data/computing device combinations, among others. Such views, in some instances, can be presented via the GUI 104 in a plurality of forms such as dashboards, charts, and graphs, among others. In some examples, the controller 102 can monitor collected data for changes based on thresholds and can aggregate or analyze the collected data over different time periods, and this data can be presented via the GUI 104. In some examples, the amount of collected data may be bounded only by available storage.

In some examples, architecture of the agent devices 108, the controller 102, and the GUI 104 do not undergo changes to support the customization of the data to collect and the particular (e.g., targeted) computing devices 106 from which to collect the data. An end user can manage computing devices 106 via the GUI 104 based on data collected by the agent device 108. In some examples, data can be collected from arbitrary data sources through a data exchange interface of the GUI 104 and the data can be collected responsive to changes to the data or a periodic schedule of the end user's choosing.

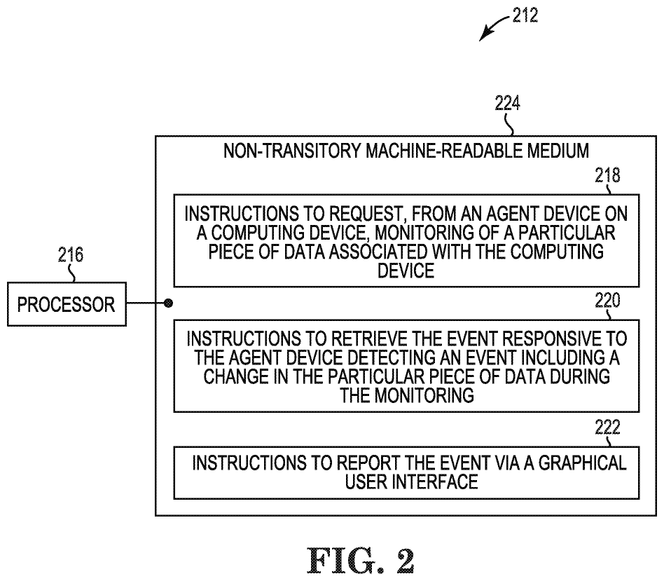

FIG. 2 illustrates another system 212 for data monitoring including a processor 216 and a non-transitory machine-readable medium (MRM) 214. System 212 can be a server or a computing device (among others) in some examples and can include the processor 216. System 212 can further include the non-transitory MRM 214, on which may be stored instructions, such as instructions 218, 220, and 222. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

The non-transitory MRM 214 may be electronic, magnetic, optical, or other physical storage device that stores executable instructions. Thus, non-transitory MRM 214 may be, for example, Random Access Memory (RAM), an Electrically-Erasable Programmable ROM (EEPROM), a storage drive, an optical disc, and the like. The non-transitory MRM 214 may be disposed within a controller and/or computing device. In this example, the executable instructions 218, 220, and 222 can be “installed” on the device. Additionally and/or alternatively, the non-transitory MRM 214 can be a portable, external or remote storage medium, for example, that allows the system 212 to download the instructions 218, 220, and 222 from the portable/external/remote storage medium. In this situation, the executable instructions may be part of an “installation package”. As described herein, the non-transitory MRM 214 can be encoded with executable instructions for data monitoring.

The non-transitory MRM 214 can, in some examples be loaded to a controller from a registry. Loaded, in some examples, can include the non-transitory MRM 214 the instructions 218, 220, and/or 222 being saved to the controller from the registry. The registry, for instance, can include an online catalog. In some instances, the non-transitory MRM 214 can be secured with a signature. This can create assurance that the non-transitory MRM 214 came from a trusted source and is a source of tamper protection. Signatures, for instance, can be considered for instructions 218, 220, and/or 222 in some examples, along with the entire non-transitory MRM 214.

The instructions 218, when executed by a processor such as the processor 216, can include instructions to request, from an agent device on a computing device, monitoring of a particular piece of data associated with the computing device. In some examples, the computing device is a particular computing device of a plurality of computing devices (e.g., in a network). The request, for instance can be for the monitoring to be performed near-continuously or at particular time intervals. For example, it may be desired that the computing device be monitored by an agent device for changes. The desired piece of data can include data that is achievable about a computing device or system of components coupled to the computing device. For instance, the desired piece of data can be data that is accessible by instructions or code that can “talk” to the data. In such an example, the particular piece of data is not part of a pre-defined subset of properties; rather, the particular piece of data is customized by an end user via a GUI and a controller. The computing device or set of computing devices and a specific manner of data collection can also be a custom choice made via the GUI.

The instructions 220, when executed by a processor such as the processor 216, can include instructions to retrieve an event including a change in the particular piece of data during the monitoring responsive to the agent device detecting the event. That is, the event can include a change or changes to the particular piece of data associated with its respective computing device. For instance, the desired piece of data may be data associated with a universal serial bus (USB) connection of a particular computing device. When a device is inserted or removed from the USB port a change occurs, which is an event. This is detected by the agent device monitoring the computing device for the particular piece of data.

In some examples, the event is reported to the controller, and the instructions 222, when executed by a processor such as the processor 216, can include instructions to report the event via a GUI. For instance, an end user can receive notification of the event via the GUI. In some examples, responsive to detection and/or reporting of the event, a predetermined action can be performed. Rules and or thresholds may be implemented when a change is detected. For example, when a change to data type X is detected, predetermined action Y is performed. Alternatively or additionally, when a change to data type X is detected on a threshold number of computing devices, predetermined action Y is performed.

For instance, using the previous example, if the event includes a USB device being inserted into a USB port of a particular computing device, the predetermined action may include rejection of the USB device (e.g., if the particular computing device is a secured computing device) or scanning of the USB device (e.g., for security threats). Examples, however, are not so limited. The predetermined action can be any of a plurality of actions responsive to any of a plurality of events and/or can include a plurality of predetermined actions. The predetermined action may not occur to the monitored computing device, but instead a different computing device, in some examples.

In some examples, the non-transitory MRM 214 can include instructions to retrieve a different event from a different agent device on a different computing device. This different event, the first-detected event, and/or any other events can be compiled. For instance, other computing devices may be monitored for the same or different data types with their own agent devices. Events, whether including the same particular data type or not may be compiled and the computing devices managed based on the compiled data.

Put another way, different agent devices can monitor for different and/or multiple data events. For instance, a first agent device on a first computing device can monitor a first computing device for data type A, data type B, and data type C. A second agent device on a second computing device can monitor a second computing device for data type A, data type D, and data type F. The different data types may be due to customization by an end user and his or her desired particular data types monitored on particular computing devices. The controller may compile all the data types A, but keep separate data types B, C, D, and F. In some instances, different data types may be compiled together. The controller can manage (e.g., monitor responses from the agent devices, inventory, review, etc.) the different data types in at least one embodiment.

In some examples, a repository of requests received via the GUI can be created. The repository can be accessible via the GUI and can include a library of scripts or executables that can be used to request particular data from particular computing devices. For instance, in some examples, end users can collect the particular data themselves using a wizard available via the GUI. The wizard provides an interface for the end user to make the request. Using the repository, the end user can choose from a menu, for instance, to aid in a request for particular data from particular computing devices. In some instances, the repository may include purchasable items. End users, in some examples, can add items to the repository.

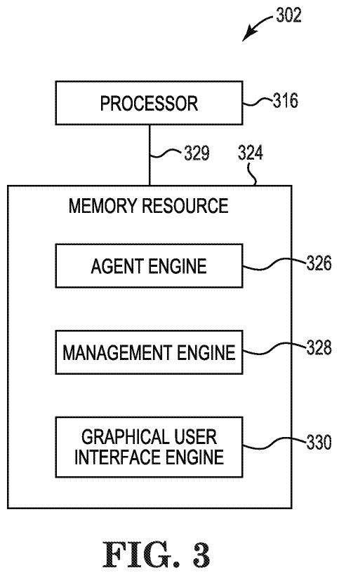

FIG. 3 illustrates a diagram of a controller 302 including a processor 316, a memory resource 324, and engines 326, 328, and 330 according to an example. For instance, the controller 302 can be a combination of hardware and instructions for data monitoring. The hardware, for example can include the processor 316 and/or the memory resource 324 (e.g., MRM, computer-readable medium (CRM), data store, etc.).

The processor 316, as used herein, can include a number of processing resources capable of executing instructions stored by the memory resource 324. The instructions (e.g., machine-readable instructions (MRI)) can include instructions stored on the memory resource 324 and executable by the processor 316 to implement a desired function (e.g., data monitoring). The memory resource 324, as used herein, can include a number of memory components capable of storing non-transitory instructions that can be executed by the processor 316. The memory resource 324 can be integrated in a single device or distributed across multiple devices. Further, the memory resource 324 can be fully or partially integrated in the same device as the processor 316 or it can be separate but accessible to that device and processor 316. Thus, it is noted that the controller 302 can be implemented on an electronic device and/or a collection of electronic devices, among other possibilities.

The memory resource 324 can be in communication with the processor 316 via a communication link (e.g., path) 329. The communication link 329 can be local or remote to an electronic device associated with the processor 316. The memory resource 324 includes engines (e.g., agent engine 326, management engine 328, GUI engine 330). The memory resource 324 can include more engines than illustrated to perform the various functions described herein.

The engines 326, 328, and 330 can include a combination of hardware and instructions to perform a number of functions described herein (e.g., data monitoring). The instructions (e.g., software, firmware, etc.) can be downloaded and stored in a memory resource (e.g., MRM) as well as a hard-wired program (e.g., logic), among other possibilities. In some examples, the engines 326, 328, and 330 may be composed on separate computing systems.

The agent engine 326 can assign a task to an agent device for detection and collection of data associated with a particular data type and a particular computing device. In some examples, the task may include specific rules chosen by the end user such as requiring an encryption key to collect the data. In some instances, the particular data type is not limited to data that the particular computing device is emitting on its own. For instance, rules or input/output data that drives computing device behavior can be collected.

The management engine 328 can retrieve and manage the collected data, and the GUI engine 330 can display the collected data via a GUI. Management of the data can include compiling and aggregating data, sorting data (e.g., based on users who can view or make changes to the data), or other management tasks. And end user can view and interact with the collected and managed data via the GUI.

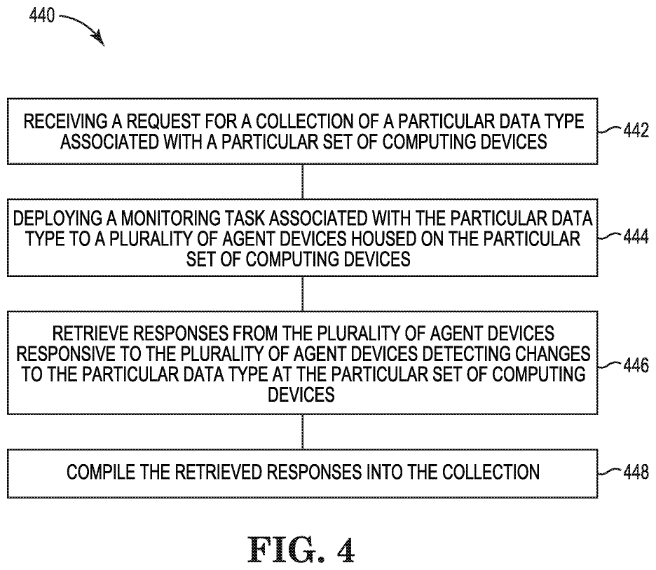

FIG. 4 illustrates a method 440 for data monitoring according to an example. The method 440 may be performed by a system 212 and/or controllers 102, 302 as described with respect to FIGS. 1-3. At 442, the method 440 includes receiving a request for a collection of a particular data type associated with a particular set of computing devices. In some examples, the request can be received at a controller via a GUI. For instance, interaction with a controller communicatively coupled to the particular set of computing devices can occur using the GUI. The controller may be a central component collecting and managing the particular data type and the particular set of computing devices (and computing devices outside the particular set).

For instance, if the particular set of computing devices includes thin client devices in a portion of a company, the particular data type may be associated with monitor inventories. For instance, users may have multiple monitors connected to their thin client for use in their work. A request may be made to monitor the monitors for inventory use.

At 444, the method 440 includes deploying a monitoring task associated with the particular data type to a plurality of agent devices housed on the particular set of computing devices. For instance, in the previous example, the monitoring task may be deployed by a controller to agent devices on the thin clients. The monitoring task may include monitoring for changes in the number of active and/or functioning monitors. An event is detected when a change occurs. For instance, when a monitor is disconnected from a port of a particular thin client, an event is detected by the associated agent device.

The method 440, at 446 includes retrieving responses from the plurality of agent devices responsive to the plurality of agent devices detecting changes to the particular data type at the particular set of computing devices. For instance, in the previous example, the agent device detects an event at the thin client (e.g., disconnection of a monitor), and the agent device sends a response to the controller indicating a change has occurred. The response can be sent/retrieved responsive to the detection or at a predetermined time.

At 448, the method 440 includes compiling the retrieved responses into the collection. For instance, responses from a plurality of thin clients can be compiled for use in inventory practices. The collection can be displayed via the GUI. In some instances, the method 440 can include managing the particular set of computing devices based on the collection. For instance, in the previous example, this can include the inventor practices. Inventory lists can be updated based on the collection, changes to particular monitors can be made (e.g., if a certain type tends to fail), users can be sent prompts about a disconnected monitor, diagnostics can be performed with respect to a disconnected or failed monitor, etc.

The method 440 can provide flexibility to end users to collect data that is desirable to them based on the ability to gather such data and to target such data gathering explicitly on a per computing device level or collection of computing device level in such a way that each computing device within the network (e.g., company enterprise) may have a distinct and differentiated set of custom properties. The method 440, in some examples, can facilitate the exposure and viewability of the data within a computing device management model.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature may refer to one or more of such elements and/or features.

What is claimed is:

1. A non-transitory machine-readable medium storing instructions executable by a processing resource to cause a computing system to:
request, from an agent device on a computing device, monitoring of a particular piece of data associated with the computing device;
responsive to the agent device detecting an event including a change in the particular piece of data during the monitoring, retrieve the event; and
report the event via a graphical user interface (GUI).

2. The medium of claim 1, further comprising the instructions executable to request the monitoring be performed near-continuously.

3. The medium of claim 1, further comprising the instructions executable to request the monitoring be performed at particular time intervals.

4. The medium of claim 1, further comprising the instructions executable to perform a predetermined action responsive to the agent device detecting the event.

5. The medium of claim 1, further comprising the instructions executable to:
retrieve a different event from a different agent device on a different particular computing device; and
compile the event and the different event,
wherein the event and the different event comprise changes to the particular piece of data associated with their respective particular computing devices.

6. The medium of claim 1, further comprising the instructions executable to:
create a repository of the request and other requests received via the GUI, wherein the repository is accessible via the GUI.

7. The medium of claim 1, wherein the medium is saved to a controller from a registry.

8. A system, comprising:
a plurality of agent devices, each one of the plurality of agent devices to:
monitor an associated computing device for changes to a particular data type; and
notify a controller of a change to the particular data type responsive to detection of the change;
the controller communicatively coupled to the plurality of agent devices to:
retrieve and compile notifications from the plurality of agent devices; and
a graphical user interface (GUI) communicatively coupled to the controller to facilitate user interaction with the controller.

9. The system of claim 8, further comprising the controller to deploy instructions to the plurality of agent devices for the monitoring responsive to receiving a request for the particular data type monitoring via the GUI.

10. The system of claim 8, further comprising the agent device to communicate with the controller only when the change is detected.

11. The system of claim 8, wherein each one of the plurality of agent devices is housed on a different one of the associated plurality of computing devices.

12. The system of claim 8, further comprising each one of the plurality of agent devices to iteratively:
monitor the associated computing device for changes to a particular data type; and
notify the controller of the changes to the particular data type responsive to detection of the changes.

13. A method, comprising:
receiving a request for a collection of a particular data type associated with a particular set of computing devices;
deploying a monitoring task associated with the particular data type to a plurality of agent devices housed on the particular set of computing devices;
retrieving responses from the plurality of agent devices responsive to the plurality of agent devices detecting changes to the particular data type at the particular set of computing devices; and
compiling the retrieved responses into the collection.

14. The method of claim 13, further comprising:
receiving the request via a graphical user interface (GUI); and
displaying the collection via the GUI.

15. The method of claim 13, further comprising managing the particular set of computing devices based on the collection.
